(19) United States
(12) Patent Application Publication
(10) Pub. No.: US 2020/0284095 A1
(43) Pub. Date: Sep. 10, 2020

(54) STEP STABILIZER LEG AND LEG ASSEMBLY

(71) Applicant: Lippert Components, Inc., Elkhart, IN (US)

(72) Inventors: Nathaniel FULLER, Granger, IN (US); Scott C. MCKINNON, Union City, MI (US)

(21) Appl. No.: 16/796,142

(22) Filed: Feb. 20, 2020

Related U.S. Application Data
(60) Provisional application No. 62/813,782, filed on Mar. 5, 2019.
(60) Provisional application No. 62/934,728, filed on Nov. 13, 2019.

(51) Int. Cl. E06C 7/42; E06C 7/44

(52) U.S. Cl. CPC E06C 7/426; E06C 7/44

(57) ABSTRACT

A step stabilizer leg is adjustable in both the angle and length of the leg. The legs are also individually adjustable to accommodate for uneven ground and are lockable and stowable with the step when it is not in use. A plate that mounts the stabilizer leg to the bottom of the step has multiple apertures that correspond to one of a few apertures adjacent to or integrated with the leg. This allows for the leg to be placed in different angles with respect to the step, including an angle that projects backwards towards the step assembly for situations when the bottom step is very close to the ground.

### CROSS-REFERENCES TO RELATED APPLICATIONS

This application claims the benefit of U.S. Provisional Patent Application No. 62/813,782, filed Mar. 5, 2019 and U.S. Provisional Patent Application No. 62/934,728, filed Nov. 13, 2019, the entire contents of each of which are herein incorporated by reference.

### STATEMENT REGARDING FEDERALLY SPONSORED RESEARCH OR DEVELOPMENT

(Not Applicable)

### BACKGROUND

The invention relates to a stabilizer leg for a stowable step assembly and, more particularly, to a step stabilizer leg that is adjustable in both the angle and length of the leg and is lockable in a fully-retracted position.

In fold-out or stowable stair designs, when the stairs are extended into a use position, the extending and retracting brackets and the like can be overly stressed during use without proper support. Stabilizer legs may be added to the extended steps for support, but it has been difficult to stow supporting legs with the steps as they tend to fall off or obstruct the retraction of the stair assembly into a stored or stowed position.

### SUMMARY

It would thus be desirable to provide a stabilizer leg for a fold-out or stowable step that is stowable and lockable with the step when not in use. The step stabilizer leg of the described embodiments is adjustable in both the angle and length of the leg. Additionally, the legs can be individually adjustable to accommodate for uneven ground. The plate that mounts the stabilizer leg to the bottom of the step has multiple apertures that correspond to one of a few apertures adjacent to or integrated with the leg. This allows for the leg to be placed in different angles with respect to the step, including an angle that projects backwards towards the step assembly for situations when the bottom step is very close to the ground, in one embodiment.

In another embodiment, two legs may be secured in a linear formation to an elongated plate with the two legs facing away from one another. In this embodiment, the two legs may be selectively pivoted towards a centerline to stabilize the step. Once the angle of the stabilizer leg is selected and secured, a plunger or spring-biased peg or pin can be pulled back to allow a telescoping portion of the leg to slide out of the outer sleeve to a length where it contacts the ground. The plunger is then released and protrudes into an aperture of the inner sleeve that corresponds to the plunger or peg aperture of the outer sleeve to lock the telescoping tubes in place.

In an exemplary embodiment, a stabilizer leg for a foldout or stowable step includes a mounting plate securable to the step and including a plurality of plate apertures, a first leg section pivotably secured to the mounting plate, and a second leg section coupled with the first leg section. The first leg section includes at least one positioning aperture and at least one supporting aperture, and the second leg section includes a plurality of leg apertures. The second leg section is telescopically displaceable relative to the first leg section such that the leg apertures are selectively positionable in alignment with the at least one supporting aperture. A foot member is secured at a distal end of the second leg section.

A first pin may be extendable through one of the plurality of plate apertures in the mounting plate and through the at least one positioning aperture in the first leg section. A second pin may be extendable through the at least one support aperture and through one of the plurality of leg apertures.

The foot member may be pivotably secured at the distal end of the second leg section. The foot member may be secured to the second leg section at a pivot point disposed at a center of the foot member.

The mounting plate may include a pair of plates or a U-shaped bracket including the plurality of plate apertures through each plate or each side of the U-shape. In this context, the first leg section may be pivotable into a position in which at least a portion of the first leg section is disposed in a channel defined by the plates or the U-shape. The first leg section may include a tab member on a bracket side of the first leg section, and the at least one positioning aperture may be disposed in the tab member. The U-shaped bracket may be provided with a depth that is sized large enough to receive the first leg section including the tab member, and wherein the plurality of plate apertures are positioned in the channel such that with the first leg section in a fully-retracted position, a pin is insertable through the plate apertures to secure the first leg section in the channel.

In some embodiments, the stabilizer leg may include two of the first leg section and two of the second leg section respectively defining first and second legs pivotably secured to the mounting plate. The first and second legs may be pivotably secured to the mounting plate on opposite sides of a centerline of the mounting plate. The first leg may be pivotable from a first retracted position engaging the mounting plate counter-clockwise to a first extended position, and the second leg may be pivotable from a second retracted position engaging the mounting plate clockwise to a second extended position. With the mounting plate in the form of a pair of plates or a U-shaped bracket, the first leg sections may be pivotable into a position in which at least a portion of each of the first leg sections is disposed in a channel defined by the plates or the U-shape.

In another exemplary embodiment, a foldout step assembly includes the stabilizer leg of the described embodiments.

In yet another exemplary embodiment, a stabilizer leg assembly for a foldout or stowable step includes a mounting plate securable to the step and having a plurality of plate apertures, a first proximal leg section pivotably secured to the mounting plate, and a first distal leg section coupled with the first proximal leg section. The first proximal leg section includes at least one positioning aperture and at least one supporting aperture, and the first distal leg section includes a plurality of leg apertures. The first distal leg section is telescopically displaceable relative to the first proximal leg section such that the leg apertures are selectively positionable in alignment with the at least one supporting aperture. A first foot member is secured at a distal end of the first distal leg section. The assembly also includes a second proximal leg section pivotably secured to the mounting plate, and second distal leg section coupled with the second proximal leg section. The second proximal leg section includes at least one positioning aperture and at least one supporting aperture, and the second distal leg section includes a plurality of leg apertures. The second distal leg section is telescopically displaceable relative to the second proximal leg section such that the leg apertures of the second distal leg section are selectively positionable in alignment with the at least one supporting aperture of the second proximal leg section. A second foot member is secured at a distal end of the second distal leg section.

The first proximal leg section and the second proximal leg section may be aligned with the mounting plate in a fully-retracted position.

### BRIEF DESCRIPTION OF THE DRAWINGS

These and other aspects and advantages will be described in detail with reference to the accompanying drawings, in which:

FIG. 1 shows a fold-out step assembly including stabilizer legs in a retracted position;

FIG. 2 shows the fold-out step assembly of FIG. 1 with one of the stabilizer legs in a supporting position;

FIG. 3 shows a stabilizer leg projecting backwards towards the step assembly for situations when the bottom step is close to the ground;

FIG. 4 shows a variation of the stabilizer leg;

FIG. 5 shows multiple configurations for the stabilizer leg shown in FIG. 4;

FIG. 6 shows another variation of the stabilizer legs in the extended position;

FIG. 7 shows the stabilizer legs of FIG. 6 in a retracted position;

FIG. 8 shows multiple configurations for the stabilizer leg shown in FIG. 6;

FIG. 9 shows the stabilizer legs of FIG. 6 installed on a fold-out step assembly in a supporting position; and

FIG. 10 shows the stabilizer legs of FIG. 6 installed on a fold-out step assembly in a retracted position.

### DETAILED DESCRIPTION

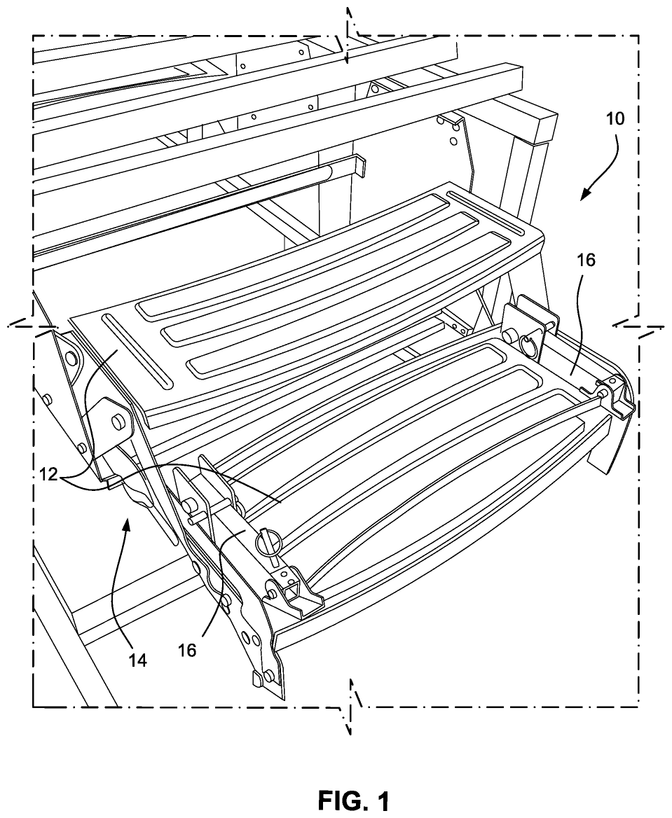

FIG. 1 shows a fold-out step assembly 10 including two steps 12 and operating brackets/mechanisms 14 that enable the fold-out step assembly 10 to be displaceable between extended and stowed positions. A pair of stabilizer legs 16 are shown in a stowed position in which the legs 16 do not interfere with stowing or storage of the step assembly 10.

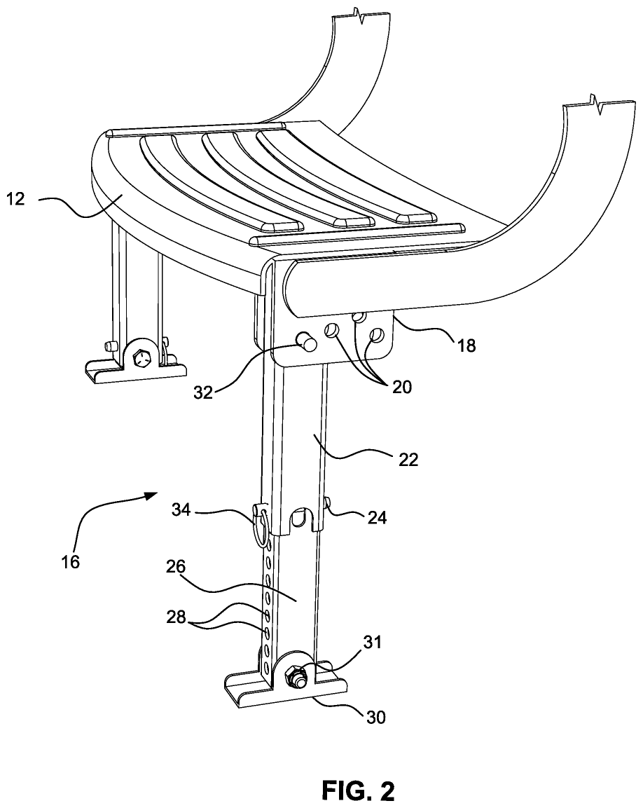

FIG. 2 shows a stabilizer leg 16 pivoted to an extended or supporting position. The stabilizer leg includes a mounting plate 18 securable to the lower step 12 and including a plurality of plate apertures 20. A first or proximal leg section 22 is pivotably secured to the mounting plate 18 and includes at least one positioning aperture (not visible in FIG. 2 but is receiving a pin through the leftmost aperture 20 in the mounting plate 18) and at least one supporting aperture 24. A second or distal leg section 26 is coupled with the first leg section 22 and includes a plurality of leg apertures 28. The second or distal leg section 26 is telescopically displaceable relative to the first or proximal leg section 22 such that the leg apertures 28 are selectively positionable in alignment with the at least one supporting aperture 24. A foot member 30 is secured at a distal end of the second leg section 26. The foot member 30 may be pivotably secured to the distal end of the second leg section. As shown, the foot member 30 is secured to the second leg section 28 at a pivot point 31 disposed at a center of the foot member 30. Alternatively, the foot member 30 may comprise a plate that has a curved or rounded profile that is secured non-pivotally to the end of the second leg section. The curve in the plate could allow the foot member 30 to contact the ground at all deploy angles without requiring a pivot.

A first pin 32 is extendible through one of the plurality of plate apertures 20 in the mounting plate 18 and through the at least one positioning aperture in the first leg section 22. A second pin 34 is extendible through the at least one support aperture 24 and through one of the plurality of leg apertures 28.

In some embodiments, the mounting plate 18 is in the form of two flat plates or a U-shaped bracket including the plurality of plate apertures 20 through each plate or through each side of the U-shape. In this context, the first or proximal leg section 22 may be pivotable into a position in which at least a portion of the first leg section 22 is disposed in a channel defined by the two plates or U-shape.

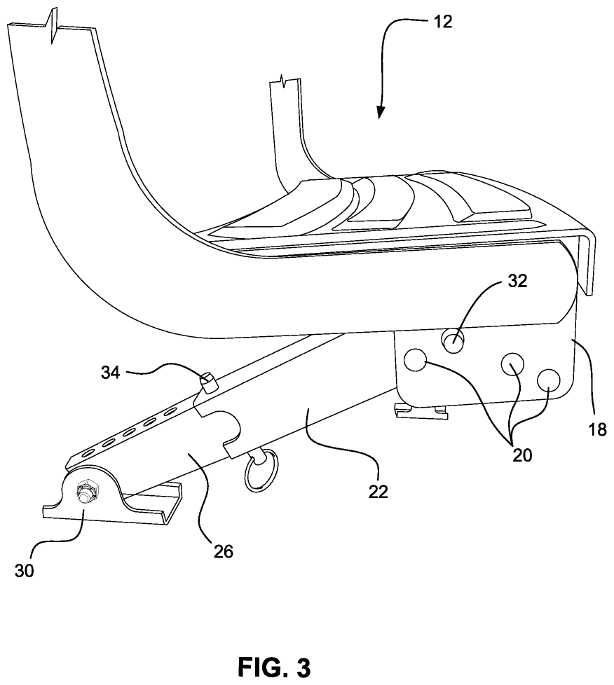

In FIG. 3, the first leg section 22 is pivoted to a position at an angle that projects backwards towards the step 12 for situations when the bottom step is very close to the ground. As shown, the first pin 32 is positioned through the middle one of the plurality of plate apertures 20 and through the positioning aperture in the first leg section 22. The first leg section 22 can be further pivoted toward the step 12 into a fully-retracted position in which the first leg section 22 is clear of the leftmost one of the plurality of plate apertures 20. In that position, the first pin 32 can be placed through the leftmost one (in FIG. 3) of the plurality of plate apertures 20 to secure the first leg section 22 in the retracted position. That is, with continued reference to FIG. 3, with the first leg section 22 in a fully-retracted position, the first pin 32 can be inserted through the mounting plate 18 under the first leg section 22.

The second or distal leg section 26 can be selectively positioned and secured via the second pin 34.

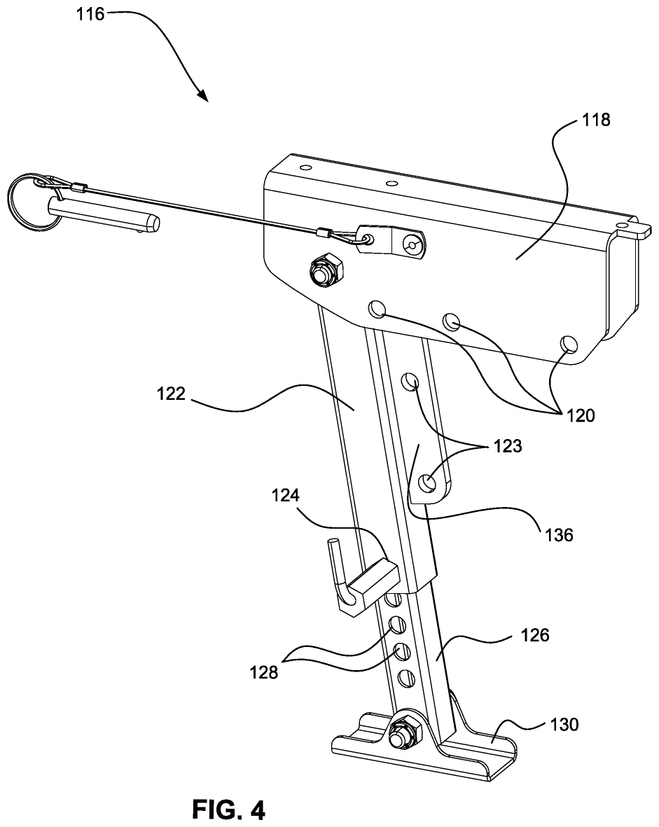

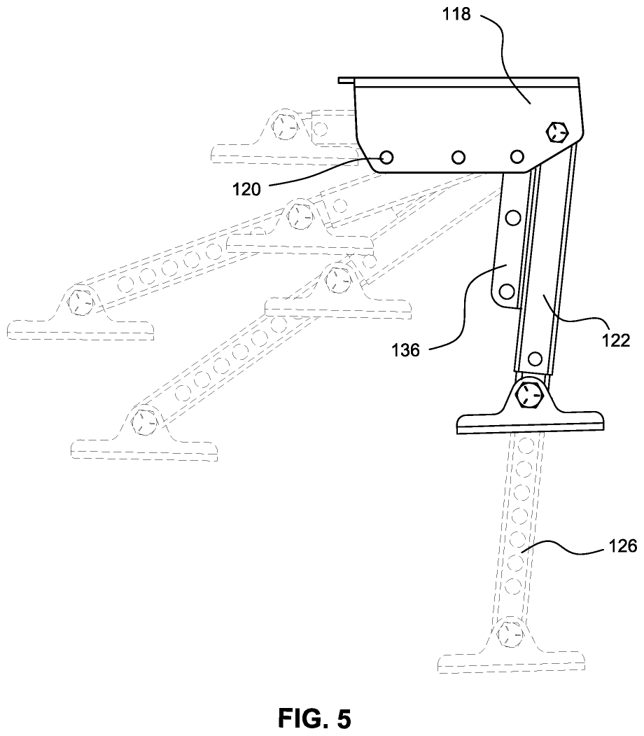

FIGS. 4 and 5 show a variation of the stabilizer leg 116. Like the first embodiment, the stabilizer leg 116 similarly includes a mounting plate 118 securable to the step and including a plurality of plate apertures 120. The first or proximal leg section 122 is pivotably secured to the mounting plate 118 and includes the at least one positioning aperture 123 and at least one supporting aperture 124. The second or distal leg section 126 is coupled with the first leg section 122 and includes the plurality of leg apertures 128. Like the first embodiment, the second leg section 126 is telescopically displaceable relative to the first leg section 122 such that the leg apertures 128 are selectively positionable in alignment with the at least one supporting aperture 124. A foot member 130 is pivotably secured at a distal end of the second leg section 126.

In this embodiment, the first leg section 122 includes a tab member 136 on a bracket side thereof. The one or more positioning apertures 123 are disposed in the tab member 136. With continued reference to FIG. 4 and with reference to FIG. 5, the U-shaped bracket 118 has a depth that is sized large enough to receive the first leg section 122 including the tab member 136. The plurality of plate apertures 120 are positioned relative to the channel formed by the U-shaped bracket 118 such that with the first leg section 122 in a fully-retracted position, a pin is insertable through the plate apertures 120 to secure the first leg section 122 in the channel. In FIG. 5, for example, with the first leg section 122 pivoted clockwise into a fully-retracted position, the first leg section 122 is positioned above the plate apertures 120, and a pin inserted through the plate apertures 120 can serve to secure the first leg section 122 in the fully-retracted position.

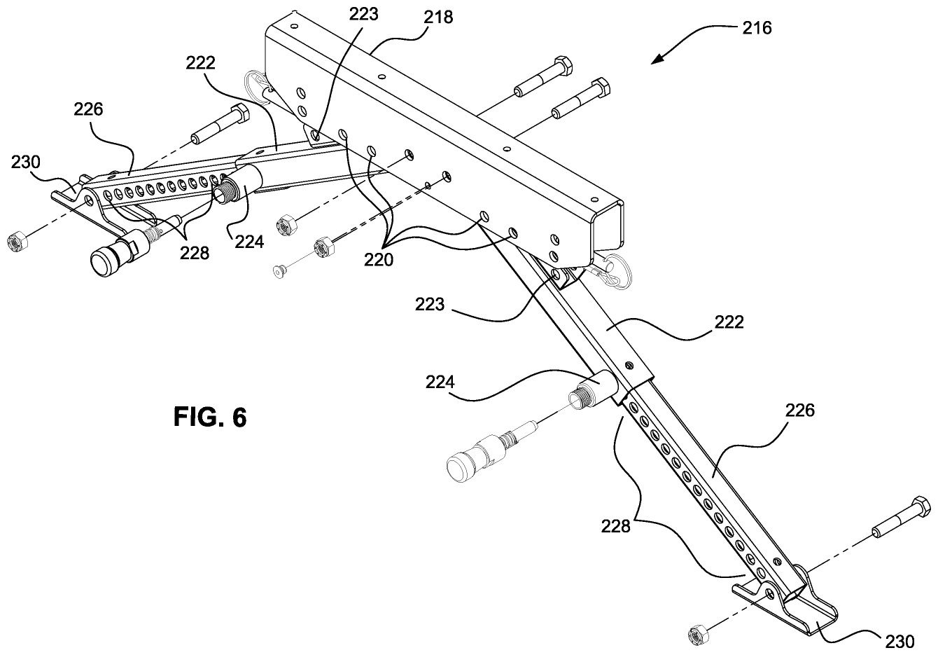

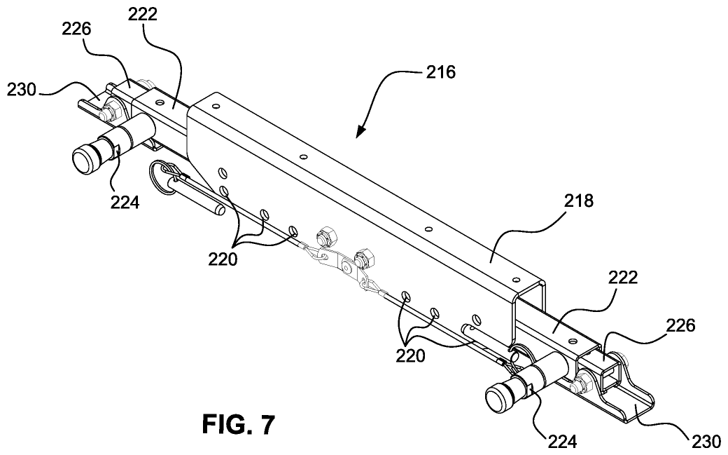

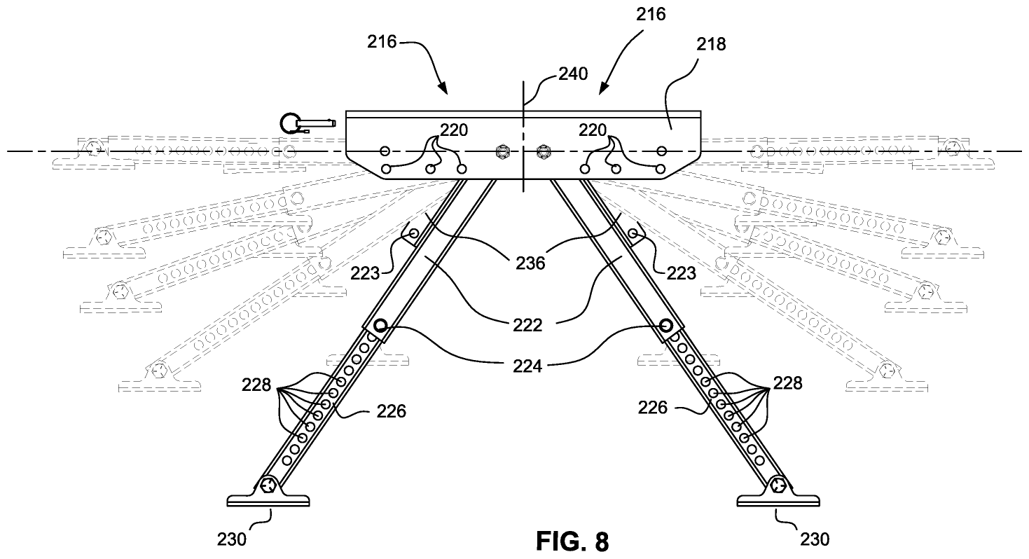

FIGS. 6-10 show a variation of the stabilizer leg as a stabilizer leg assembly 216. Like the first embodiment, the stabilizer leg assembly 216 similarly includes a mounting plate 218 securable to the step and including a plurality of plate apertures 220. The first or proximal leg section 222 is pivotably secured to the mounting plate 218 and includes the at least one positioning aperture 223 and at least one supporting aperture 224. The second or distal leg section 226 is coupled with the first leg section 222 and includes the plurality of leg apertures 228. Like the first embodiment, the second leg section 226 is telescopically displaceable relative to the first leg section 222 such that the leg apertures 228 are selectively positionable in alignment with the at least one supporting aperture 224. A foot member 230 is pivotably secured at a distal end of the second leg section 226. Like the second embodiment, the stabilizer leg assembly 216 similarly includes tab member 236 on the first leg section 222. The U-shaped bracket 218 also has a depth that allows for the first leg section 222 to be secured within the channel, as seen in FIGS. 7-8.

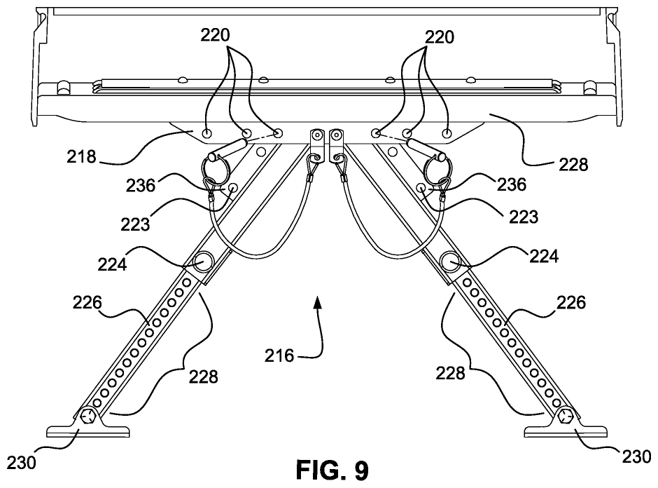

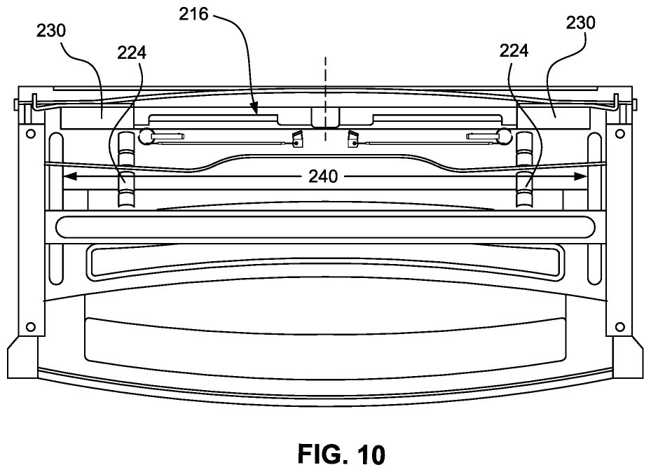

In this embodiment, the U-shaped bracket 218 is elongated and houses two linear first leg sections 222 with corresponding second leg sections 226 that face away from each other in the retracted position. The first leg sections 222 are pivotally attached to the U-shaped bracket 218 proximate a centerline 240 of the bracket. With reference to FIG. 8, the first leg sections may be secured in one of multiple angular positions radially about the centerline 240 of the bracket by insertion of a pin through the plate apertures 220 to secure the first leg section 222 in the channel. The second leg sections 226 are then selectively extended and secured in place by a pin through corresponding apertures in the first and second leg sections 224, 228. As seen in FIGS. 9 and 10, the stabilizer leg assembly 216 may be mounted underneath and parallel with a bottom step of a fold-out step assembly. As noted in FIG. 8, at least one foot member 230 of the stabilizer leg assembly 216 may selectively extend past the outer ends of the step tread. As seen in FIGS. 7 and 10, the stabilizer leg assembly 216 may be secured and stowed within the U-shaped bracket 218 by inserting a pin within an aperture 220 of the bracket while the first leg section 222 is flush and completely enclosed within the bracket. When the stabilizer leg assembly 216 is fully-retracted within the U-shaped bracket 218 with the second leg sections 226 also fully retracted, the fold-out step assembly may be stowed or deployed without the stabilizer leg assembly impeding movement.

The stabilizer leg is fully adjustable in both the angle and length of the leg. The legs are also individually adjustable to accommodate for uneven ground and are lockable and stowable with the step when it is not in use.

The multiple apertures in the mounting plate allow for the leg to be placed in different angles with respect to the step, including an angle that projects backwards towards the step assembly in some embodiments for situations when the bottom step is very close to the ground. As seen in FIGS. 4 and 9, the pin for securing the leg with the mounting plate may be tethered to the mounting plate for ease of the user. Once the angle of the stabilizer leg is selected and secured, the telescoping portion of the leg can be positioned in contact with the ground. As seen in FIGS. 6 and 7, the pin for securing the second or distal leg section with the first or proximal leg section may be spring-loaded or may otherwise be tethered to the leg. The apertures of the mounting bracket also allow for the leg to be secured flush with the mounting bracket in a horizontal position for stowing the leg. With the stabilizer leg secured in the horizontal or fully-retracted position and the telescoping legs locked in the fully-retracted position, it is then possible to stow the folding step without fear that the leg will fall off or get in the way of storing the step assembly.

Although embodiments have been described with the stabilizer leg integrated with a folding step, the stabilizer leg could also be integrated into other types of retractable or stowable step designs.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A stabilizer leg for a foldout or stowable step, the stabilizer leg comprising:
a mounting plate securable to the step and including a plurality of plate apertures;
a first leg section pivotably secured to the mounting plate, the first leg section including at least one positioning aperture and at least one supporting aperture;
a second leg section coupled with the first leg section and including a plurality of leg apertures, the second leg section being telescopically displaceable relative to the first leg section such that the leg apertures are selectively positionable in alignment with the at least one supporting aperture; and
a foot member secured at a distal end of the second leg section.

2. A stabilizer leg according to claim 1, further comprising a first pin extendable through one of the plurality of plate apertures in the mounting plate and through the at least one positioning aperture in the first leg section.

3. A stabilizer leg according to claim 2, further comprising a second pin extendable through the at least one support aperture and through one of the plurality of leg apertures.

4. A stabilizer leg according to claim 1, wherein the foot member is pivotably secured at the distal end of the second leg section.

5. A stabilizer leg according to claim 4, wherein the foot member is secured to the second leg section at a pivot point disposed at a center of the foot member.

6. A stabilizer leg according to claim 1, wherein the mounting plate comprises a pair of plates or a U-shaped bracket including the plurality of plate apertures through each plate or each side of the U-shape, wherein the first leg section is pivotable into a position in which at least a portion of the first leg section is disposed in a channel defined by the plates or the U-shape.

7. A stabilizer leg according to claim 6, wherein the first leg section comprises a tab member on a bracket side of the first leg section, and wherein the at least one positioning aperture is disposed in the tab member.

8. A stabilizer leg according to claim 7, wherein the U-shaped bracket has a depth that is sized large enough to receive the first leg section including the tab member, and wherein the plurality of plate apertures are positioned in the channel such that with the first leg section in a fully-retracted position, a pin is insertable through the plate apertures to secure the first leg section in the channel.

9. A stabilizer leg according to claim 1, comprising two of the first leg section and two of the second leg section respectively defining first and second legs pivotably secured to the mounting plate.

10. A stabilizer leg according to claim 9, wherein the first and second legs are pivotably secured to the mounting plate on opposite sides of a centerline of the mounting plate.

11. A stabilizer leg according to claim 10, wherein the first leg is pivotable from a first retracted position engaging the mounting plate counter-clockwise to a first extended position, and wherein the second leg is pivotable from a second retracted position engaging the mounting plate clockwise to a second extended position.

12. A stabilizer leg according to claim 9, wherein the mounting plate comprises a pair of plates or a U-shaped bracket including the plurality of plate apertures through each plate or each side of the U-shape, wherein the first leg sections are pivotable into a position in which at least a portion of each of the first leg sections is disposed in a channel defined by the plates or the U-shape.

13. A stabilizer leg according to claim 12, wherein the first leg sections comprise a tab member on a bracket side of the first leg sections, and wherein the at least one positioning aperture is disposed in the tab members.

14. A stabilizer leg according to claim 13, wherein the U-shaped bracket has a depth that is sized large enough to receive the first leg sections including the tab members, and wherein the plurality of plate apertures are positioned in the channel such that with the first leg sections in a fully-retracted position, respective pins are insertable through the plate apertures to secure the first leg sections in the channel

15. A foldout step assembly comprising the stabilizer leg of claim 1.

16. A stabilizer leg assembly for a foldout or stowable step, the stabilizer leg assembly comprising:
a mounting plate securable to the step and including a plurality of plate apertures;
a first proximal leg section pivotably secured to the mounting plate, the first proximal leg section including at least one positioning aperture and at least one supporting aperture;
a first distal leg section coupled with the first proximal leg section and including a plurality of leg apertures, the first distal leg section being telescopically displaceable relative to the first proximal leg section such that the leg apertures are selectively positionable in alignment with the at least one supporting aperture;
a first foot member secured at a distal end of the first distal leg section;
a second proximal leg section pivotably secured to the mounting plate, the second proximal leg section including at least one positioning aperture and at least one supporting aperture;
a second distal leg section coupled with the second proximal leg section and including a plurality of leg apertures, the second distal leg section being telescopically displaceable relative to the second proximal leg section such that the leg apertures of the second distal leg section are selectively positionable in alignment with the at least one supporting aperture of the second proximal leg section; and
a second foot member secured at a distal end of the second distal leg section.

17. A stabilizer leg assembly according to claim 16, wherein the first proximal leg section and the second proximal leg section are aligned with the mounting plate in a fully-retracted position.

18. A stabilizer leg assembly according to claim 16, wherein the mounting plate comprises a pair of plates or a U-shaped bracket including the plurality of plate apertures through each plate or each side of the U-shape, wherein the first and second proximal leg sections are pivotable into a position in which at least a portion of each of the first and second proximal leg sections is disposed in a channel defined by the plates or the U-shape.

19. A stabilizer leg according to claim 18, wherein the first and second proximal leg sections each comprises a tab member on a bracket side thereof, and wherein the at least one positioning aperture is disposed in the tab members.
